(19) United States
(12) Patent Application Publication
(10) Pub. No.: US 2025/0360348 A1
(43) Pub. Date: Nov. 27, 2025

(54) ONBOARD FIRE DETECTION IN REFUSE COLLECTION VEHICLES

(71) Applicant: The Heil Co., Chattanooga, TN (US)

(72) Inventors: Brian Huston Ham, Huntsville, AL (US); David C. Gentry, Chattanooga, TN (US); Joseph Henry Mills, Dunwoody, GA (US); Phillip A. Kendrick, Chattanooga, TN (US)

(21) Appl. No.: 19/217,387

(22) Filed: May 23, 2025

Related U.S. Application Data
(60) Provisional application No. 63/651,723, filed on May 24, 2024.

(51) Int. Cl. A62C 37/40; A62C 3/07; B65F 3/02

(52) U.S. Cl. CPC A62C 37/40; A62C 3/07; B65F 3/02; B65F 2003/0283

(57) ABSTRACT

A system includes a refuse collection vehicle and at least one detector device coupled to a portion of the refuse collection vehicle. The refuse collection vehicle includes a chassis, a cab coupled to a front portion of the chassis, and a storage body coupled to the chassis rearward of the cab. The at least one detector device is configured to detect one or more phenomena resulting from a fire in the refuse collection vehicle.

### CROSS-REFERENCE TO RELATED APPLICATION

This application claims the benefit under 35 U.S.C. § 119(e) of U.S. Patent Application No. 63/651,723, entitled “Onboard Fire Detection in Refuse Collection Vehicles,” filed May 24, 2024, which is incorporated herein by reference in its entirety.

### TECHNICAL FIELD

This disclosure relates to systems and methods for detecting and resolving a fire in a refuse collection vehicle.

### BACKGROUND

Refuse collection vehicle fires can be costly, resulting in damage to roadways, property, and the refuse collection vehicle itself. Refuse collection vehicle fires can be caused by various factors including electrical issues (e.g., issues with the vehicle's battery and/or electrical cables), hydraulic fluid leaks, frozen wheel bearings, tire fires, holes in the exhaust system, and “hot loads.” A “hot load” is a term used to describe a load of refuse that ignites, smolders, spontaneously combusts, or becomes toxic as a result of incompatible waste mixing in the hopper of a refuse collection vehicle. Such “hot loads” are typically caused by customers of a refuse collection company improperly placing hazardous materials in their refuse containers, which are then serviced by a refuse collection vehicle. These hazardous materials may include batteries, electronics, hazardous chemicals, hot ashes, used charcoal bags, combustible chemicals, and pressurized containers, to name a few. Improvements in the systems and methods of detection of refuse collection vehicle fires are continually sought.

### SUMMARY

Implementations of the present disclosure are generally directed to detecting a fire in a refuse collection vehicle by using one or more detector device devices. More particularly, implementations of the present disclosure are directed to collecting data using one or more detector device devices coupled to a refuse collection vehicle and/or other image and/or video data to detect the presence (or absence) of one or more phenomena resulting from a fire in the refuse collection vehicle and sending alert notifications and/or performing other action(s) based on identifying the one or more phenomena resulting from the fire in the refuse collection vehicle.

In an example implementation, a system includes: a refuse collection vehicle, including: a chassis; a cab coupled to a front portion of the chassis; a storage body coupled to the chassis rearward of the cab; and at least one detector device coupled to a portion of the refuse collection vehicle, the at least one detector device configured to detect one or more phenomena resulting from a fire in the storage body of the refuse collection vehicle.

Embodiments may include one or more of the following features.

In some embodiments, the at least one detector device includes a flame detector.

In certain embodiments, the at least one detector device includes a smoke detector.

In some embodiments, the at least one detector device includes a heat detector.

In certain embodiments, wherein the at least one detector device includes a gas detector.

In some embodiments, the gas detector is an oxygen detector configured to detect a decrease in oxygen resulting from the fire.

In some embodiments, the one or more phenomena includes one or more of a flame, a spark, smoke, temperature, and gas.

In certain embodiments, the at least one detector device is coupled to a hopper or the storage body of the refuse collection vehicle.

In some embodiments, a field-of-view of the at least one detector device covers an interior space defined by the hopper or the storage body.

In certain embodiments, the at least one detector device is coupled to roof of the storage body.

In some embodiments, the refuse collection vehicle includes a hopper cover, and the at least one detector device is coupled to the hopper cover.

In certain embodiments, the refuse collection vehicle further includes a camera configured to capture image data or video data of the one or more phenomena resulting from the fire in the refuse collection vehicle.

In some embodiments, the camera is an infrared (IR) camera.

In some embodiments, the refuse collection vehicle further includes a fire suppression system.

In certain embodiments, the fire suppression system is one or more of a clean agent-based fire suppression system, chemical clean agent-based fire suppression system, inert gas-based fire suppression system, and carbon dioxide-based fire suppression system.

In some embodiments, the system further includes a computing device, and the at least one detector device is configured to transmit, to the computing device, a signal indicating the one or more phenomena resulting from the fire has been detected in the refuse collection vehicle.

In certain embodiments, the computing device is an onboard computing device of the refuse collection vehicle.

In some embodiments, the computing device is configured to trigger a fire suppression system of the refuse collection vehicle based on receiving the signal indicating the one or more phenomena resulting from the fire in the refuse collection vehicle has been detected, the fire suppression system configured to extinguish the fire in the refuse collection vehicle.

In certain embodiments, the refuse collection vehicle includes a display device within the cab, and the computing device is configured to display image data or video data of the one or more phenomena resulting from the fire in the refuse collection vehicle on the display device based on receiving the signal indicating the one or more phenomena resulting from the fire in the refuse collection vehicle has been detected.

In some embodiments, the computing device is configured to transmit the image data or video data to one or more remote computing devices for display.

In certain embodiments, the computing device is configured to trigger an eject cycle based on receiving the signal indicating the one or more phenomena resulting from the fire in the refuse collection vehicle has been detected.

In some embodiments, triggering the eject cycle includes receiving an input from an operator of the refuse collection vehicle before starting the eject cycle.

In certain embodiments, the computing device is configured to override a packing function of the refuse collection vehicle based on receiving the signal indicating the one or more phenomena resulting from the fire in the refuse collection vehicle has been detected.

In some embodiments, the computing device is configured to trigger a compacting cycle based on receiving the signal indicating the one or more phenomena resulting from the fire in the refuse collection vehicle has been detected.

In some embodiments, the computing device is configured to generate a visual alert or an audible alert based on receiving the signal indicating the one or more phenomena resulting from the fire in the refuse collection vehicle has been detected.

In an aspect combinable with the example implementation, a method of detecting one or more phenomena resulting from a fire in a refuse collection vehicle includes: detecting, using at least one detector device coupled to the refuse collection vehicle, the one or more phenomena resulting from the fire; transmitting, from the at least one detector device to a computing device, a signal indicating the at least one phenomena resulting from the fire has been detected by the at least one detector device; and in response to receiving the signal, triggering, using the computing device, one or more actions including at least one of: i) extinguishing the fire in the refuse collection vehicle, and ii) alerting an operator of the refuse collection vehicle of the detected at least one phenomena.

In some embodiments, the one or more phenomena includes one or more of a flame, a spark, smoke, temperature, and gas.

In certain embodiments, the step of extinguishing the fire in the refuse collection vehicle includes triggering a fire suppression system of the refuse collection vehicle, the fire suppression system configured to extinguish the fire in the refuse collection vehicle.

In some embodiments, the step of triggering the fire suppression system includes triggering a release of one or more of a chemical agent, an inert gas, water, or carbon dioxide directed to a location of the one or more phenomena in the refuse collection vehicle.

In certain embodiments, the refuse collection vehicle includes a display device, and the method includes alerting an operator of the refuse collection vehicle of the detected at least one phenomena includes displaying image data or video data of the one or more phenomena on the display device.

In some embodiments, the step of triggering the one or more actions includes triggering an eject cycle of the refuse collection vehicle.

In certain embodiments, the step of triggering the eject cycle includes receiving an input from an operator of the refuse collection vehicle before starting the eject cycle.

In some embodiments, the step of triggering the one or more actions includes overriding a packing function of the refuse collection vehicle.

In some embodiments, the step of triggering the one or more actions includes triggering a compaction cycle of the refuse collection vehicle.

In some embodiments, the step of triggering the one or more actions includes triggering a packing cycle of the refuse collection vehicle.

In some embodiments, the step of triggering the one or more actions includes triggering an activation of the ejector of the refuse collection vehicle.

In certain embodiments, the step of triggering the one or more actions includes generating a visual alert or an audible alert indicating the one or more the one or more phenomena resulting from the fire in the refuse collection vehicle has been detected.

Particular implementations of the subject matter described in this specification can be implemented so as to realize one or more of the following advantages.

For example, the systems, methods, and refuse collection vehicles of the present disclosure can advantageously detect a fire in the refuse collection vehicle at an early stage (e.g., during the ignition and/or growth stages). The detector devices of the refuse collection vehicles of the disclosure can accomplish this by detecting phenomena resulting from the fire, such as flames, sparks, smoke, heat, and/or gas that are present at an early stage of a fire.

The current method of detecting refuse collection vehicle fires while the refuse collection vehicle is running (e.g., during a route) is to rely on the operator of the refuse collection vehicle noticing the fire or being alerted by other people nearby. Furthermore, the current protocol to respond to a refuse collection vehicle fire when the refuse collection vehicle is running (e.g., during a route) includes ejecting the refuse load into the street. In some implementations, the detector devices of the refuse collection vehicles of the disclosure can prevent a fire or an explosion from occurring in a refuse collection vehicle by performing one or more of the following actions: alerting the operator, triggering a fire suppression system, triggering a compacting cycle of the refuse collection vehicle, triggering an eject cycle of the refuse collection vehicle, triggering a packing cycle of the refuse collection vehicle, triggering an activation of the ejector of the refuse collection vehicle, overriding a packing function of the refuse collection vehicle, and displaying image and/or video data of the part of the refuse collection vehicle where the phenomenon resulting from the fire is occurring (e.g., inside the hopper).

The sooner a fire in a refuse collection vehicle is detected, the greater the chance of salvaging the refuse collection vehicle. Thus, in some implementations, the systems, methods, and refuse collection vehicles of the present disclosure can prevent loss of the refuse collection vehicle due to fire. Additionally, in some implementations, the systems, methods, and refuse collection vehicles of the present disclosure can reduce the potential risk of harm to the operator of the refuse collection vehicle and other people proximate the refuse collection vehicle, and reduce the potential risk of damaging other property and/or roadways.

It is appreciated that methods in accordance with the present specification may include any combination of the aspects and features described herein. That is, methods in accordance with the present specification are not limited to the combinations of aspects and features specifically described herein, but also include any combination of the aspects and features provided.

The details of one or more implementations of the subject matter described in this disclosure are set forth in the accompanying drawings and the description below. Other features, objects, and advantages of the subject matter will be apparent from the description and drawings, and from the claims.

### DESCRIPTION OF DRAWINGS

FIG. 1 depicts an example system for collecting refuse including a refuse collection vehicle equipped with a detector device.

FIG. 2 is a side view of the refuse collection vehicle of the system FIG. 1 further including a camera.

FIG. 3 is a perspective view of a hopper of a refuse collection vehicle including a detector device and a fire suppression system.

FIG. 4 is a schematic illustration of an example control system or controller for a refuse collection vehicle.

FIG. 5 depicts an example method for the detection of a fire in a refuse collection vehicle using the system of FIG. 1.

### DETAILED DESCRIPTION

The refuse collection vehicle of the present disclosure includes one or more detector devices. The detector device(s) of the refuse collection vehicle can be used to detect one or more phenomena resulting from a fire in the refuse collection vehicle. “In the scope of the present disclosure, by “detector device,” we refer to a mechanism, such as a sensor, that detects, measures, or otherwise responds to a physical property of a phenomenon associated with a fire.”

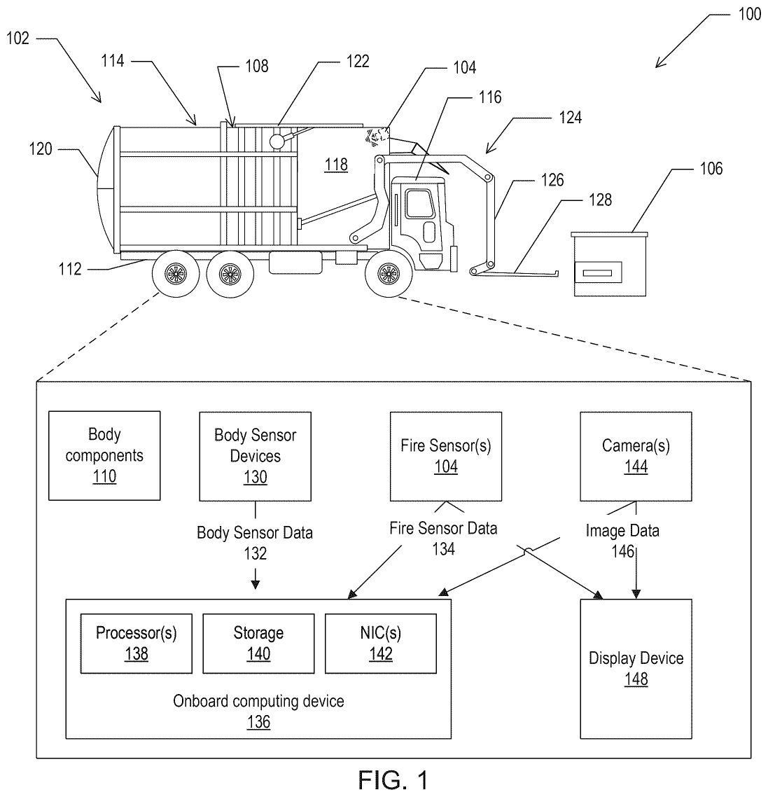

FIG. 1 illustrates an example system 100 for the detection of a fire in a refuse collection vehicle. The system 100 includes a vehicle 102 and one or more detector devices 104 coupled to the vehicle 102. The vehicle 102 can be a refuse collection vehicle that operates to collect and transport refuse. The refuse collection vehicle can also be described as a garbage collection vehicle, or garbage truck. The vehicle 102 can be configured to lift a carry can 106 that contains refuse, and empty the refuse in the carry can 106 into a hopper 108 of the vehicle 102, to enable transport of the refuse to a collection site, compacting of the refuse, and/or other refuse handling activities. The vehicle 102 can also handle carry cans in other ways, such as by transporting the carry cans to another site for emptying.

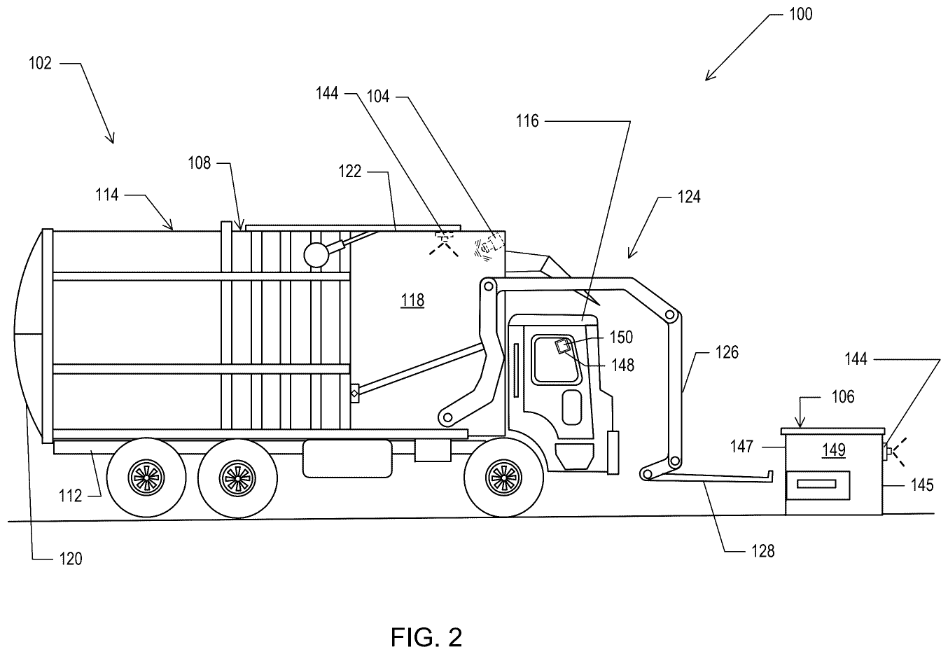

The vehicle 102 can include various body components 110 that are appropriate for the particular type of vehicle. For example, the vehicle 102 is depicted as a front-loading refuse collection vehicle in FIGS. 1 and 2 and includes body components 110 such as a chassis 112, a storage body 114 coupled to a back portion of the chassis 112, and a cab 116 coupled to a front portion of the chassis 112. The storage body 114 includes a plurality of panels 118, a tailgate 120, and a hopper cover 122. The hopper 108 is defined by the panels 118, the tailgate 120, and the hopper cover 122 and includes a compartment that receives the collected refuse. The hopper cover 122 is configured to cover the opening of the hopper 108. As shown in FIGS. 1 and 2, the storage body 114 and the hopper 108 extend rearward of the cab 116. The vehicle 102 includes a lift assembly 124 further including a pair of opposing lift arms 126 and a pair of opposing forks 128. The pair of lift arms 126 and the pair of forks 128 extend forward of the cab 116.

Other types of refuse collection vehicles including, but not limited to, side-loading and rear-loading refuse collection vehicles are also suitable to be a vehicle 102 of the system 100. For example, the vehicle 102 may be a side-loading refuse collection vehicle with an automated side loader (ASL) (e.g., a lift assembly that extends from a side of the storage body 114). A vehicle with an ASL may include body components 110 involved in the operation of the ASL, such as an arm and/or grabbers as well as other body components, such as a pump, a tailgate, a packer, and so forth. In some examples, the vehicle 102 may be a side-loading refuse collection vehicle without a lift assembly. In some embodiments, the vehicle 102 may be a rear-loading refuse collection vehicle that may include body components 110, such as a pump, blade, tipper, and so forth. A front-loading refuse collection vehicle, such as the example shown in FIGS. 1 and 2, may include body components 110, such as a pump, tailgate, packer, fork assembly, commercial grabbers, and so forth. Body components 110 may also include other types of components that operate to bring garbage into a hopper of a refuse collection vehicle, compress and/or arrange the garbage in the refuse collection vehicle, and/or expel the garbage from the refuse collection vehicle.

The vehicle 102 can include any number of body sensor devices 130 that sense body component(s) 110 and generate body sensor data 132 describing the operation(s) and/or the operational state of various body components 110. The body sensor devices 130 may be arranged in the body components 110, or in proximity to the body components 110, to monitor the operations of the body components 110. The body sensor devices 130 emit signals that include the body sensor data 132 describing the body component operations, and the signals may vary appropriately based on the particular body component being monitored. The body sensor devices 130 can be provided on the storage body 114 of the vehicle 102 to evaluate cycles and/or other parameters of various body components 110. For example, as described in further detail herein, the body sensor devices 130 can detect and/or measure the particular position and/or operational state of body components such a lift arm, a fork assembly, and so forth.

The body sensor devices 130 can include, but are not limited to, an analog sensor, a digital sensor, a Controller Area Network (CAN) bus sensor, a magnetostrictive sensor, a radio detection and ranging (RADAR) sensor, a light detection and ranging (LIDAR) sensor, a laser sensor, an ultrasonic sensor, an infrared (IR) sensor, a stereo camera sensor, a three-dimensional (3D) camera, an infrared camera (e.g., a forward-looking infrared (FLIR) camera), a camera (e.g., a charged-coupled device (CCD) camera or a complementary metal-oxide-semiconductor (CMOS) camera), in-cylinder sensors, or a combination thereof. In some implementations, the body sensor devices 130 may be incorporated into the various body components 110. Alternatively, the body sensor devices 130 may be separate from the body components 110.

The vehicle 102 can also include one or more detector devices 104 that can be used to detect one or more phenomena resulting from a fire in the vehicle 102. For example, as will be described in further detail herein, the detector device 104 can be used to detect one or more of a flame, a spark, smoke, heat, and gas occurring in the vehicle 102 (e.g., in the hopper 108 or elsewhere in the storage body 114). In some implementations, one or more body components 110 of the vehicle 102 can be controlled based on the output of the detector devices 104.

In some implementations, the detector devices 104 are configured to generate detector device data, such as radiant intensity signals, indicating the presence of one or more phenomena resulting from a fire in the vehicle 102. In some embodiments, the detector device 104 can be a flame detector including one or more ultraviolet (UV) light sensors, one or more infrared (IR) light sensors, one or more multi-spectrum IR sensors, one or more near IR sensors, or any combination thereof. For example, the detector device 104 can be a flame detector configured to detect UV, IR, and/or near IR radiation (e.g., radiant intensity signals) emitted by a flame. The flame detector can include a photoelectric detective circuit, a signal conditioning circuit, a microprocessor system, an input/output (I/O) circuit, and a cooling system. The flame detector can be configured to convert, via the photoelectric detective circuit and the signal conditioning circuit, the detected radiant intensity signal into a voltage signal. The voltage signal, as will be described in further detail herein, is then processed by the onboard computing device 136 in the vehicle 102 into an actionable output signal. In some embodiments, the detector device 104 can be a flame detector configured to detect radiant emissions ranging between about 2.95 microns (μm) to about 4.35 μm and between about 185 nanometers (nm) to about 260 nm. In some embodiments, the detector device 104 can be a flame detector that is responsive to a hydrocarbon (e.g., gasoline, propane, methane, alcohol, JP-4 jet fuel, JP-3 jet fuel, etc.) flame and/or a non-hydrocarbon (e.g., hydrogen, silane, hydrazine, etc.) flame. In some embodiments, the detector device 104 can be a flame detector that detects a spark and/or a flame in less than about 3 seconds. In some implementations, the detector device 104 can be configured to detect one or more of smoke, temperature, and gas.

In some implementations, the detector devices 104 are configured to output analog signals or digital signals indicating the presence of one or more phenomena resulting from a fire in the vehicle 102. In some implementations, the detector devices 104 are configured to output Controller Area Network (CAN) messages to indicate the presence of one or more phenomena resulting from a fire in the vehicle 102. In some embodiments, the detector devices 104 are configured to output digital signals indicating the presence of one or more phenomena resulting from a fire in the vehicle 102 that can be transmitted via a wireless and/or a wired network (e.g., a Wi-Fi® and/or an Ethernet® network).

In some implementations, the body sensor data 132 and detector device data 134 may be communicated from the body sensor devices 130 and the detector devices 104, respectively, to an onboard computing device 136 in the vehicle 102. In some embodiments, the detector device data 134 includes voltage signals generated by a flame detector. In some instances, the onboard computing device 136 is an under-dash device (UDU), and may also be referred to as the “gateway.” Alternatively, the onboard computing device 136 may be placed in some other suitable location in or on the vehicle 102. The body sensor data 132 and detector device data 134 may be communicated from the body sensor devices 130 and the detector devices 104, respectively, to the onboard computing device 136 over a wired connection (e.g., an internal bus) and/or over a wireless connection. In some implementations, a Society of Automotive Engineers J1939 standard bus, in conformance with International Organization of Standardization (ISO) standard 11898, connects the various the body sensor devices 130 and the detector devices 104 with the onboard computing device 136. In some implementations, a Controller Area Network (CAN) bus connects the various the body sensor devices 130 and the detector devices 104 with the onboard computing device 136. For example, a CAN bus in conformance with ISO standard 11898 can connect the body sensor devices 130 and the detector devices 104 with the onboard computing device 136. In some implementations, the body sensor data 132 and/or the detector device data 134 digitize the signals that communicate the body sensor data 132 and the detector device data 134 before sending the signals to the onboard computing device 136 if the signals are not already in a digital format.

The analysis of the body sensor data 132 and the detector device data 134 can be performed at least partly by the onboard computing device 136, e.g., by processes that execute on the processor(s) 138. For example, the onboard computing device 136 can execute processes that perform an analysis of the body sensor data 132 to determine the current position of the body components 110, such as the lift arm position or the fork assembly position. In some implementations, an onboard program logic controller or an onboard mobile controller perform analysis of the body sensor data 132 to determine the current position of the body components 110. The onboard computing device 136 can execute processes that perform an analysis of the detector device data 134 to detect phenomena resulting from a fire in the vehicle 102, such as a flame, a spark, smoke, temperature, and/or gas. In some implementations, an onboard program logic controller or an onboard mobile controller perform analysis of the detector device data 134 to determine if one or more phenomena resulting from a fire in the vehicle 102 is detected.

The onboard computing device 136 can include one or more processors 138 that provide computing capacity, data storage 140 of any suitable size and format, and one or more network interface controller(s) (NIC(s)) 142 that facilitate communication of the onboard computing device 136 with other device(s) over one or more wired or wireless networks.

In some implementations, the vehicle 102 includes a body controller that manages and/or monitors various body components of the vehicle 102. The body controller of the vehicle 102 can be connected to multiple sensors in the storage body 114 of the vehicle 102. The body controller can transmit one or more signals over the J1939 network, or other wiring on the vehicle 102, when the body controller senses a state change from any of the sensors. These signals from the body controller can be received by the onboard computing device 136 that is monitoring the J1939 network.

In some implementations, the onboard computing device 136 is a multi-purpose hardware platform. The onboard computing device 136 can include a under dash unit (UDU) and/or a window unit (WU) (e.g., camera) to record video and/or audio operational activities of the vehicle 102. The onboard computing device hardware subcomponents can include, but are not limited to, one or more of the following: a central processing unit (CPU), a memory or data storage unit, a CAN interface, a CAN chipset, NIC(s) such as an Ethernet port, USB port, serial port, I2c lines(s), and so forth, I/O ports, a wireless chipset, a global positioning system (GPS) chipset, a real-time clock, a micro SD card, an audio-video encoder and decoder chipset, and/or external wiring for CAN and for I/O. The onboard computing device 136 can also include temperature sensors, battery and ignition voltage sensors, motion sensors, CAN bus sensors, an accelerometer, a gyroscope, an altimeter, a GPS chipset with or without dead reckoning, and/or a digital CAN interface (DCI). The DCI cam hardware subcomponent can include the following: a CPU, memory, CAN interface, CAN chipset, Ethernet port, USB port, serial port, I2c lines, I/O ports, a wireless chipset, a GPS chipset, a real-time clock, and external wiring for CAN and/or for I/O. In some implementations, the onboard computing device 136 is a smartphone, tablet computer, and/or other portable computing device that includes components for recording video and/or audio data, processing capacity, transceiver(s) for network communications, and/or sensors for collecting environmental data, telematics data, and so forth.

Referring to FIG. 2, one or more cameras 144 can be mounted on or integrated into the vehicle 102 and can operate in conjunction with the detector devices 104. The camera(s) 144 can be a standard onboard non-infrared camera. Alternatively, or in addition, the camera(s) 144 can include a FLIR camera. For example, a FLIR camera can be used in place of the standard non-IR camera. In another example, the FLIR camera can be used in combination with the standard non-IR camera. In some embodiments, an IR sensor can be used either in conjunction with or as an alternative to the camera(s) 144. For example, the IR sensor can be used in combination with the standard non-IR camera, in combination with the FLIR camera, or independently as a detector device 104.

The camera(s) 144 each generate image data 146, as shown in FIG. 1, that includes one or more images of a scene internal to and in proximity to the vehicle 102. In some implementations, one or more cameras 144 are arranged to capture image(s) and/or video of the hopper 108 before, after, and/or during the operations of the vehicle 102 during a route (e.g., before, after, and/or during a dump cycle, which includes the emptying of refuse from a carry can 106 into a compartment defined by the hopper 108 of the vehicle 102). For example, the camera(s) 144 can be arranged to image the contents of the hopper 108 in the vehicle 102. In some embodiments, the camera(s) 144 can be mounted to one or more walls of the hopper 108. In some implementations, the camera(s) 144 can be mounted on an upper portion of one of the panels 118 that define the hopper 108. In some embodiments, the camera(s) 144 can be mounted on the hopper cover 122, as shown in FIG. 2. In some implementations, the camera(s) 144 can be mounted behind an ejector panel, facing into the body of the vehicle 102. In some embodiments, the camera(s) 144 can be mounted on the storage body 114, facing into the area behind the ejector panel. In some examples, the camera(s) 144 can be mounted inside the storage body 114, for example, inside of a shroud or a protective cover mounted in the storage body 114. In some implementations, the camera(s) 144 can be mounted externally on the vehicle 102, such as on the outside of the storage body 114. In these implementations, the camera lens can be positioned to view the interior of the storage body 114 through a porthole. This setup may offer added protection for the camera(s) 144 by shielding them from direct exposure to waste and mechanical components.

In some embodiments, the camera(s) 144 can be mounted on a front portion of the carry can 106, facing forward, in the direction of travel, such that during a dump cycle, the carry can 106 is inverted from the travel position shown in FIG. 2 to an inverted position, thereby enabling the camera(s) 144 to capture images and/or video of the contents within the hopper 108 during a dump cycle. As shown in FIG. 2, in some embodiments, the camera(s) 144 can be mounted on a forward exterior surface of a front wall 145 of the carry can 106. In some implementations, the camera(s) 144 can be mounted on an interior surface of a back wall 147 of the carry can 106, facing forward, in the direction of travel.

Alternatively, in some embodiments, the camera(s) 144 can be mounted externally on the back wall 147 of the carry can 106, facing forward, and positioned such that the camera lens can view the interior of the carry can 106 through a porthole. In either one of these last two configurations, the camera(s) 144 can capture images and/or video of the contents within the carry can 106 while in a stowed position and during a dump cycle as well as capturing images and/or video of the contents within the hopper 108 during a dump cycle. In some implementations, the camera(s) 144 can be mounted on an interior surface of the carry can 106 (e.g., on an interior surface of a side wall 149 of the carry can 106). In such a configuration, the camera(s) 144 can capture images and/or video of the contents within the carry can 106 while in a stowed position and during a dump cycle. In some embodiments, the camera(s) 144 can be mounted on an arm of an ASL of a side-loading refuse collection vehicle.

In some implementations, the camera(s) 144 are controlled to capture image data and/or video data of a hazard (e.g., one or more phenomena resulting from a fire in the refuse collection vehicle) detected by the detector devices 104 coupled to vehicle 102. As will be described in further detail herein, the image data or video data captured by the camera(s) 144 can be combined with data captured by the detector devices 104 to detect one or more phenomena resulting from a fire in the vehicle 102. For example, the data captured by the detector devices 104 can be transmitted to a network gateway, and the transmitted detector device data can be combined with the image data or video data to create one or more of a video, an image, a timestamp, an event, and a GPS-tracked event.

In some implementations, the camera(s) 144 are communicably coupled to a display device 148 to communicate images and/or video captured by the camera(s) 144 to the display device 148. In some implementations, the display device 148 is placed within the interior of the vehicle 102. For example, the display device 148 can be placed within the cab 116 of the vehicle 102 such that the images and/or video can be viewed by an operator of the vehicle 102 on a screen 150 of the display device 148. In some implementations, the display device 148 is a heads-up display that projects the images and/or video captured by the camera(s) 144 onto the windshield of the vehicle 102 for viewing by an operator of the vehicle 102. In some implementations, the images and/or video captured by the camera(s) 144 can be communicated to a display device of the onboard computing device 136 in the vehicle 102. Images and/or video captured by the camera(s) 144 can be communicated to the onboard computing device 136 over a wired connection (e.g., an internal bus) and/or over a wireless connection. In some implementations, a network bus (e.g., a J1939 network bus, a CAN network bus, etc.) connects the camera(s) 144 with the onboard computing device 136. In some implementations, the camera(s) 144 are incorporated into various body components 110. Alternatively, the camera(s) 144 may be separate from the body components 110.

One or more body sensor devices 130 can be situated to determine the state and/or detect the operations of the body components 110. In some embodiments, the vehicle 102 includes one or more body sensor devices 130 that are arranged to detect the position of the pair of lift arms 126 and/or the pair of forks 128. For example, the body sensor device(s) 130 can provide data about the current position of the pair of lift arms 126 and/or the pair of forks 128 throughout a cycle to dump refuse from the carry can 106 into the hopper 108 of the vehicle 102. In some implementations, the body sensor device(s) 130 are located in one or more cylinders of the refuse collection vehicle 102. In some examples, a first body sensor device 130 is located inside a cylinder used for raising the pair of lift arms 126 and a second body sensor device 130 is located inside a cylinder used for moving the pair of forks 128. In some implementations, a body sensor device 130 is located on the outside of a housing containing the cylinder coupled to a lift arm 126. In some examples, a body sensor device 130 is an in-cylinder, magnetostrictive sensor.

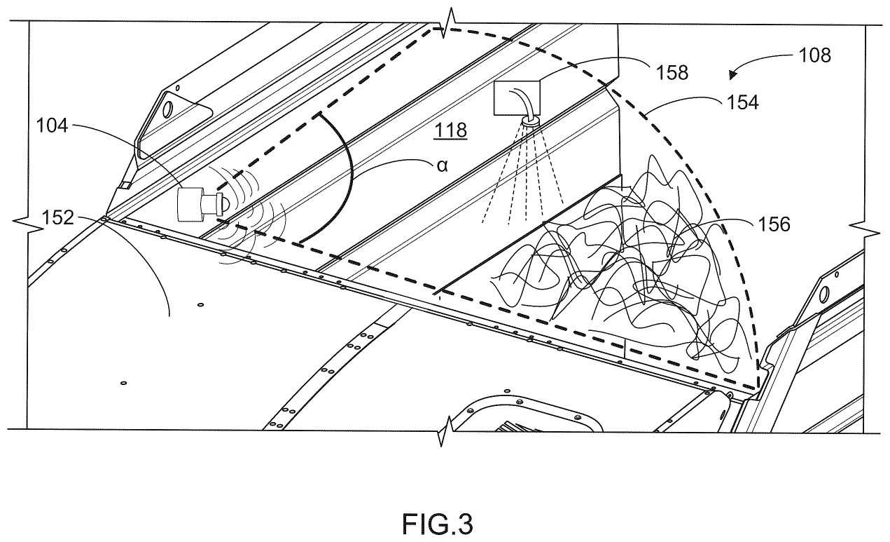

Referring to FIG. 3, the detector device 104 is typically mounted with its field-of-view covering an area where there may be a fire hazard in the vehicle 102 (e.g., in the interior space defined by the hopper 108 that holds the collected refuse). For example, as depicted in FIG. 3, the vehicle 102 can include a detector device 104 that is coupled to an upper, internal surface of a panel 118 that is proximate to a cab protector 152. The detector device 104 has a field-of-view 154 covering an area within the hopper 108 in which the refuse 156 is deposited. In some embodiments, the field-of-view 154 has an angle alpha (α) ranging from about 120 degrees to about 180 degrees. In some examples, the detector device 104 is coupled to an internal surface of the hopper cover 122 of the vehicle 102. In some embodiments, the detector device(s) 104 is coupled to or mounted in an upper corner of the hopper 108. In some embodiments, the detector device(s) 104 is coupled to or mounted on an inner surface of one or more a side walls of the hopper 108. In some embodiments, the detector device(s) 104 is coupled to or mounted on an inner surface of a roof of the storage body 114. The detector device(s) 104 can be coupled using one or more mechanical fasteners (e.g., bolts or screws). In some embodiments, the detector device(s) 104 are equipped to detect phenomena resulting from a fire in the refuse 156 contained within the storage body 114. In some embodiments, the vehicle 102 can include one or more detector devices 104 (e.g., one, two, three, four, or five detector devices 104) mounted in the hopper 108.

Still referring to FIG. 3, the vehicle 102 can further include a fire suppression system 158. In some embodiments, the fire suppression system 158 is one or more of a clean agent-based fire suppression system, chemical clean agent-based fire suppression system, inert gas-based fire suppression system, and carbon dioxide-based fire suppression system.

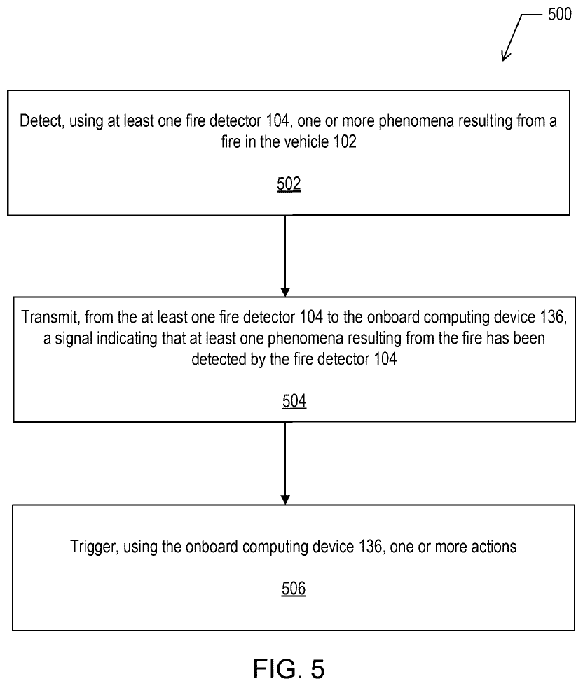

FIG. 5 depicts an example method 500 of detecting and responding to a fire in the vehicle 102. At step 502, the example method includes detecting, using at least one detector device 104 coupled to the vehicle 102, the one or more phenomena resulting from the fire. At step 504, the example method includes transmitting, from the at least one detector device 104 to the onboard computing device 136, a signal indicating the at least one phenomena resulting from the fire has been detected by the detector device 104. Furthermore, at step 506 the example method includes, in response to receiving the signal, triggering, using the onboard computing device 136, one or more actions, as described in further detail herein. For example, the one or more actions can include extinguishing the fire in the refuse collection vehicle and/or alerting an operator of the vehicle 102 of the detected fire hazard (e.g., detected phenomena resulting from the fire).

In some implementations, the detector device(s) 104 can transmit a CAN message to the onboard computing device 136 of the vehicle 102 indicating the presence of one or more phenomena (e.g., a spark, a flame, smoke, an elevated temperature, and/or gas) resulting from a fire in the vehicle 102. In some examples, the detector device 104 can transmit a CAN message to the onboard computing device 136 of the vehicle 102 indicating a radiant intensity signal indicative of a flame has been detected in the hopper 108 or storage body 114 of the vehicle 102. Similarly, the detector device 104 can transmit a CAN message to the onboard computing device 136 of the vehicle 102 indicating an elevated temperature indicative of a fire hazard has been detected in the hopper 108 or storage body 114 of the vehicle 102.

In response to receiving a signal from one or more of the detector devices 104 indicating that the presence of one or more phenomena (e.g., a spark, a flame, smoke, an elevated temperature, and/or gas) resulting from a fire in the vehicle 102 has been detected, the onboard computing device 136 can perform one or more actions to record and/or to respond to the detected fire hazard. In some implementations, the onboard computing device 136 controls a fire suppression system 158 of the vehicle 102 in order to prevent or mitigate the detected fire hazard. For example, in response to receiving a signal from the detector device 104 coupled to a hopper 108 or hopper cover 122 indicating that one or more phenomena (e.g., a spark, a flame, smoke, an elevated temperature, and/or gas) resulting from a fire in the vehicle 102 has been detected (e.g., in the refuse 156 located in the hopper 108), the onboard computing device 136 can trigger the fire suppression system 158 of the vehicle 102 to extinguish the fire. In some implementations, triggering the fire suppression system includes triggering a release of one or more of a chemical agent, an inert gas, and carbon dioxide directed to a location of the one or more phenomena in the vehicle 102. In some implementations, the fire suppression system 158 can be stopped and/or disengaged in response to receiving a signal from the detector device 104 and/or the onboard computing device 136 indicating that the fire in the vehicle 102 (e.g., in the storage body 114) has been extinguished and there is no longer any fire detected.

In some implementations, the onboard computing device 136 controls the body controller which further controls one or more body components 110 of the vehicle 102 in order to prevent or mitigate the detected fire hazard. For example, in response to receiving a signal from the detector device 104 coupled to a hopper 108 or hopper cover 122 indicating that one or more phenomena (e.g., a spark, a flame, smoke, an elevated temperature, and/or gas) resulting from a fire in the vehicle 102 has been detected (e.g., in the refuse 156 located in the hopper 108), the onboard computing device 136 can trigger an operational event of one or more body components 110. For example, in some embodiments, the onboard computing device 136 can trigger an eject cycle to unload or discharge the refuse 156 containing the detected fire hazard. In some embodiments, the onboard computing device 136 can automatically trigger an operational event of one or more body components 110 or it can require a user input (e.g., user authorization) prior to triggering an operational event of one or more body components 110.

In some embodiments, the triggering of the eject cycle is not automated, such that the onboard computing device 136 requires an input from an operator of the vehicle 102 prior to starting the eject cycle. For example, in some embodiments, a notification and/or an alarm is provided to the operator of the vehicle 102 inside the cab 116 alerting the operator of the fire in the vehicle 102. Next, in some embodiments, a request for confirmation of fire is provided to the operator of the vehicle 102 via a user interface (e.g., a touchscreen, a push button, etc.). In response to receiving the confirmation of fire from the operator, the onboard computing device 136 instructs the body controller to cause the vehicle 102 to perform an eject cycle (e.g., causes the tailgate 120 to open and packer panel to push refuse 156 containing the detected fire hazard out of the hopper 108 and storage body 114). In some implementations, a request for authorization to perform a eject cycle is provided to the operator of the vehicle 102 in addition to the request for confirmation of fire. For example, once the operator of the vehicle 102 confirms the fire, the operator further authorizes the eject cycle, and the onboard computing device 136 proceeds to instruct the body controller to trigger the eject cycle to unload or discharge the refuse 156 containing the detected fire hazard.

In some implementations, the triggering of the eject cycle is automated and no input from an operator of the vehicle 102 is required to start the eject cycle to unload or discharge the refuse 156 containing the detected fire hazard. For example, in response to receiving the signal from one or more of the detector devices 104 indicating that the presence of one or more phenomena (e.g., a spark, a flame, smoke, an elevated temperature, and/or gas) resulting from a fire in the vehicle 102 has been detected, the onboard computing device 136 instructs the body controller to automatically open the tailgate 120 and operates a packer panel to push refuse 156 in the hopper 108 and storage body 114 out of the vehicle 102 through a rear opening.

As previously described herein, the onboard computing device 136 receives signals that include the body sensor data 132, detector device data 134, image data 146, and data indicating the status of the vehicle 102 (e.g., data indicating if the vehicle 102 is in motion or at rest). In some implementations, in response to receiving a signal from the detector device 104 indicating that one or more phenomena (e.g., a spark, a flame, smoke, an elevated temperature, and/or gas) resulting from a fire in the vehicle 102 has been detected (e.g., in the refuse 156 located in the hopper 108), the onboard computing device 136 can also, in addition to generating any of the instructions previously described herein, automatically check the body sensor data 132, image data 146, and data indicating the status of the vehicle 102, and based on these data, execute different instructions.

In some embodiments, in response to receiving a signal from the detector device 104 indicating that one or more phenomena resulting from a fire in the vehicle 102 has been detected, the onboard computing device 136 can instruct the body controller to limit the hydraulic functions and/or limit the flow of hydraulic fluid within the hydraulic actuator systems of certain body components (e.g., the pair of lift arms 126).

In another example, in response to receiving a signal from the detector device 104 indicating that one or more phenomena resulting from a fire in the vehicle 102 has been detected, in response to receiving a signal from the body sensor devices 130 indicating that the body components (e.g., the lift assembly 124) are not being used (e.g., the pair of lift arms 126 are in a raised, stowed position), and in response to receiving a signal indicating the vehicle is moving, the onboard computing device 136 can instruct the body controller to prevent the pair of lift arms 126 from being lowered.

In another example, in response to receiving a signal from the detector device 104 indicating that one or more phenomena resulting from a fire in the vehicle 102 has been detected, in response to receiving a signal from the body sensor devices 130 indicating that the body components (e.g., the lift assembly 124) are being used and/or a dump cycle is being performed, and in response to receiving a signal indicating the vehicle is stopped, the onboard computing device 136 can instruct the body controller to cause the vehicle 102 to lower the pair of lift arms 126 replace the carry can 106 to the ground and avoid adding the refuse 156 into the hopper 108 to avoid adding additional fuel to the “hot load.”

In other examples, in response to receiving a signal from the detector device 104 indicating that one or more phenomena resulting from a fire in the vehicle 102 has been detected and in response to receiving a signal from the body sensor devices 130 indicating that the pair of lift arms 126 are not in the raised, stowed position, the onboard computing device 136 can control the pair of lift arms 126 to be placed in the raised, stowed position to prevent any further dump cycles until the detector device(s) 104 no longer detect one or more phenomena resulting from a fire in the vehicle 102.

In some examples, in response to receiving a signal from the detector device 104 coupled to a hopper 108 or hopper cover 122 indicating that one or more phenomena (e.g., a spark, a flame, smoke, an elevated temperature, and/or gas) resulting from a fire in the vehicle 102 has been detected (e.g., in the refuse 156 located in the hopper 108), the onboard computing device 136 can trigger a compaction function of the packer of the vehicle 102 to compact the refuse load as a way to extinguish or partially suppress the fire by reducing its access to oxygen. For example, the onboard computing device 136 can trigger a compaction cycle sequence that is programmed to occur in response to a fire detection signal. In other implementations, the packer operation has an “override” button that a user may activate to compact the refuse load to extinguish or partially extinguish the fire by reducing its access to oxygen. In some embodiments, partially suppressing the fire by triggering a compaction function may provide additional time for the operator to ensure the vehicle 102 is in a safe location and give the operator sufficient time to safely step away from the vehicle 102.

In some embodiments, the onboard computing device 136 can automatically trigger the compaction cycle in response to receiving a signal indicating the presence of a fire in the vehicle 102 or it can require a user input (e.g., user authorization) prior to triggering the compaction cycle in response to receiving a signal indicating the presence of a fire in the vehicle 102. For example, in some implementations, the triggering of the compaction cycle is automated and no input from an operator of the vehicle 102 is required to start the compaction cycle to compact the refuse 156 containing the detected fire hazard in response to receiving a signal indicating the presence of a fire in the vehicle 102. Alternatively, in some embodiments, the triggering of the compaction cycle is not automated, such that the onboard computing device 136 requires an input from an operator of the vehicle 102 prior to starting the compaction cycle in response to receiving a signal indicating the presence of a fire in the vehicle 102.

In some embodiments, in response to receiving the signal from one or more of the detector devices 104 indicating that the presence of one or more phenomena (e.g., a spark, a flame, smoke, an elevated temperature, and/or gas) resulting from a fire in the vehicle 102 has been detected, the onboard computing device 136 can determine based on the body sensor devices 130 that a packing cycle has been initiated and, in response, cause the packer to return to a forward position in the storage body 114 to prevent further packing and/or compression of the refuse 156 contained within the storage body 114.

In some embodiments, in response to receiving the signal from one or more of the detector devices 104 indicating that the presence of one or more phenomena (e.g., a spark, a flame, smoke, an elevated temperature, and/or gas) resulting from a fire in the vehicle 102 has been detected, the onboard computing device 136 can automatically trigger a packing cycle in response to receiving a signal indicating the presence of a fire in the vehicle 102 or it can require a user input (e.g., user authorization) prior to triggering the packing cycle. In some embodiments, initiating the packing cycle may extinguish or partially suppress the fire by obstructing the opening in the ejector, thereby limiting the inflow of ambient air and reducing the fire's access to oxygen. The triggering of the packing cycle in response to the fire applies to front-loading refuse collection vehicles given that in this type of vehicles, the packer moves refuse from the hopper 108 to the storage body 114, and the ejector discharges compacted refuse.

In some embodiments, in response to receiving the signal from one or more of the detector devices 104 indicating that the presence of one or more phenomena (e.g., a spark, a flame, smoke, an elevated temperature, and/or gas) resulting from a fire in the vehicle 102 has been detected, the onboard computing device 136 can automatically trigger activation of the ejector, while the tailgate 120 is locked and/or closed, in response to receiving a signal indicating the presence of a fire in the vehicle 102 or it can require a user input (e.g., user authorization) prior to triggering the activation of the ejector. In some implementations, activating the ejector may extinguish or partially suppress the fire by activating a movement of the ejector that blocks airflow and reduces the fire's access to oxygen. In some embodiments, once activated, the ejector slides rearward, advancing the compacted refuse toward the closed and/or locked tailgate. This action reduces the available internal volume and limits the fire's access to oxygen. The triggering of the activation of the ejector in response to a fire can apply to both front-loading and side-loading refuse collection vehicles.

In some implementations, in response to receiving a signal from one or more of the detector devices 104 indicating that the presence of one or more phenomena (e.g., a spark, a flame, smoke, an elevated temperature, and/or gas) resulting from a fire in the vehicle 102 has been detected, the onboard computing device 136 can cause a visual alert and/or an audible alert to be generated that alerts an operator of the vehicle 102 to the presence of the detected fire hazard. The visual alert and/or an audible alert can be generated along with one or more of the functions triggered by the onboard computing device 136 described elsewhere herein in response to the detection of one or more phenomena resulting from a fire in the vehicle 102. In some implementations, a visual alert is displayed on the screen 150 of display device 148 inside the cab 116 of the vehicle 102 in response to receiving a signal from one or more of the detector devices 104 indicating that the presence of one or more phenomena (e.g., a spark, a flame, smoke, an elevated temperature, and/or gas) resulting from a fire in the vehicle 102 has been detected. In some implementations, the onboard computing device 136 controls one or more body components 110 of the vehicle 102 based on an operator of the vehicle 102 acknowledging, or failing to acknowledge, an alert generated in response to detecting a fire hazard in the vehicle 102. For example, in response to receiving a signal from one or more of the detector devices 104 indicating that the presence of one or more phenomena (e.g., a spark, a flame, smoke, an elevated temperature, and/or gas) resulting from a fire in the vehicle 102 has been detected, the onboard computing device 136 can cause a visual alert to be displayed within the cab 116 of the vehicle 102 (e.g., on the screen 150 of display device 148), and the onboard computing device 136 can prevent the start of an ejection cycle until the operator of the vehicle 102 has provided an input to acknowledging the displayed alert.

In some implementations, in response to receiving a signal from one or more of the detector devices 104 indicating that the presence of one or more phenomena (e.g., a spark, a flame, smoke, an elevated temperature, and/or gas) resulting from a fire in the vehicle 102 has been detected, the onboard computing device 136 can store information related to the detected fire hazard, including, but not limited to, GPS coordinates corresponding to the location of the vehicle 102 at the time of detection of the fire hazard, image data and/or video data of the detected fire hazard, and a timestamp corresponding to the time that the fire hazard was detected by the detector device 104. The data related to the detected fire hazard can be stored (e.g., in a database) by the onboard computing device 136 or by a remote computing device (i.e., a computing device located remotely from the vehicle 102).

In some implementations, in response to receiving a signal from one or more of the detector devices 104 indicating that the presence of one or more phenomena (e.g., a spark, a flame, smoke, an elevated temperature, and/or gas) resulting from a fire in the vehicle 102 has been detected, the onboard computing device 136 causes one or more cameras 144 coupled to the vehicle 102 to begin capturing image and/or video data of the fire hazard detected by the detector device 104. In some embodiments, the one or more cameras 144 can also be controlled to stop capturing age and/or video data in response to one or more of the detector devices 104 indicating that the presence of one or more phenomena resulting from a fire in the vehicle 102 is no longer detected (e.g., indicating that the fire has been extinguished). By controlling the camera(s) 144 to only capture data when a fire is ongoing, data storage requirements can be advantageously minimized.

The image data and/or video data captured by the one or more cameras 144 can include a timestamp, and the data captured by the camera(s) 144 can be identified as corresponding to a detected fire hazard based on a signal received from a detector device 104. The onboard computing device 136 or a remote computing device can process the data captured by the camera(s) 144 and the signals received from the detector devices 104 to determine image and/or video data corresponding to a detected fire hazard and store the corresponding image and/or video data together with other data related to the detected fire hazard. For example, in some embodiments, the image and/or video data corresponding to a detected fire hazard can be image(s) and/or video data including timestamps that correspond to the same time that the signal is generated by the detector device 104. Alternatively, the image and/or video data corresponding to a detected fire hazard can be image(s) and/or video data including timestamps in a range of time that is a predetermined amount of time before the signal is generated by the detector device 104 to a predetermined amount of time after the signal is generated by the detector device 104. In some implementations, the GPS coordinates of the vehicle 102 at the time of detection of the fire hazard detected by a detector device 104 can be determined and stored together with other data related to the fire hazard detected by the detector device 104.

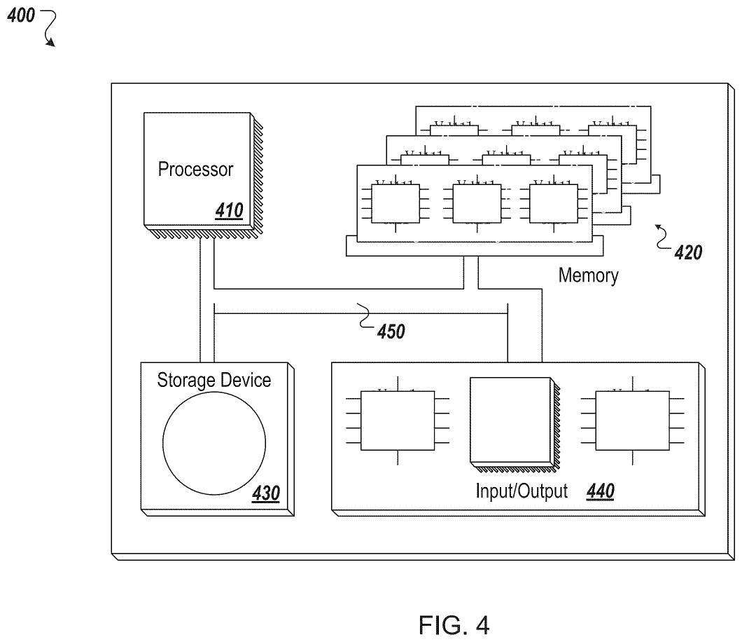

FIG. 4 depicts an example computing system, according to implementations of the present disclosure. The system 400 may be used for any of the operations described with respect to the various implementations discussed herein. For example, the system 400 may be included, at least in part, in one or more of the onboard computing device 136, and/or other computing device(s) or system(s) described herein. The system 400 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 400 includes a processor 410, a memory 420, a storage device 430, and an input/output device 440. Each of the components 410, 420, 430, and 440 are interconnected using a system bus. The processor 410 is capable of processing instructions for execution within the system 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a joystick. In some implementations, the input/output device 440 includes a display unit for displaying graphical user interfaces. For example in some implementations, the input/output device 440 is a display device that includes one or more buttons and/or a touchscreen for receiving input from a user. In some implementations, the input/output device 440 includes a keyboard and/or a pointing device. In some implementations, the input/output device 440 is located within a cab of a refuse collection vehicle (e.g., within cab 116 of vehicle 102). For example, the input/output device 440 can be attached to or incorporated within a dashboard inside the cab of a refuse collection vehicle.

While certain embodiments have been described, other embodiments are possible.

For example, while the vehicle 102 has been described as including a detector device 104 that can be a flame detector, other types of detector devices are possible. For example, in some embodiments, the vehicle 102 can include one or more detector devices that are smoke detectors, heat detectors, and/or gas detectors. In some implementations, the detector device 104 includes one or more gas detectors that can detect one or more of flammable gases that are fire risk indicators, combustion byproduct gases that are fire detection indicators, or specialty or industrial gases. Non-limiting examples of flammable gases include methane, propane, butane, hydrogen, acetylene, and ethanol. Non-limiting examples of combustion byproduct gases include carbon monoxide, carbon dioxide, nitrogen dioxide, and sulfur dioxide. Non-limiting examples of specialty or industrial gases include ammonia and hydrogen sulfide.

In some implementations, the detector device 104 includes a gas detector configured to detect oxygen (e.g., an oxygen sensor). For example, an oxygen sensor can be used to detect a fire in the vehicle 102 by monitoring changes in the ambient oxygen concentration. Fires consume oxygen rapidly and release combustion gases, leading to a noticeable drop in oxygen levels. In some implementations, the oxygen sensor continuously measures the surrounding oxygen concentration inside a portion of the vehicle (e.g., inside the hopper 108, storage body 114, and/or the cab 116), which under normal conditions is about 20.9%. In some embodiments, the oxygen sensor is an electrochemical or zirconia-based type of oxygen sensor. In general, when a fire or smoldering combustion occurs, the oxygen level in an area proximate to the fire decreases. In the case of a fire or smoldering combustion in the vehicle 102, if the decreased oxygen level falls below a predefined threshold (e.g., below 19.5%), the oxygen sensor triggers an alert. For example, the oxygen sensor can transmit a signal to the onboard computing device 136 to indicate a low oxygen condition has been detected. In response, the onboard computing device 136 initiates the same actions as those triggered by the other detector devices 104 described elsewhere herein. For example, the triggered actions can include extinguishing the fire in the refuse collection vehicle and/or alerting an operator of the vehicle 102 of the detected fire hazard.

In some embodiments, the oxygen sensor may be useful in an environment where visual detection methods may be obstructed. For example, the refuse inside storage body 114 is sufficiently enclosed such that, in the event of a fire inside the storage body 114, oxygen would likely be consumed more rapidly than it can be replenished by incoming air. As a result, positioning the oxygen sensor inside the storage body 114 can help to detect fire or overheat conditions effectively. For example, the oxygen sensor can be placed inside (e.g., mounted on an inner wall) of the storage body 114. In some embodiments, the oxygen sensor is positioned near the rear of the vehicle 102, at the upper portion of the storage body 114, close to the roof. This placement may help ensure the oxygen sensor remains out of the way while still effectively monitoring the storage body 114 for fire or overheat conditions. In some implementations, the oxygen sensor is used in conjunction with any of the other sensors, detector devices 104, and/or camera(s) 144 described herein to enhance fire detection reliability.

In some implementations, the detector device 104 is a signaling line circuit fire detection system (also referred to herein as a “salt loop fire detection system”). The salt loop fire detection system is a specialized safety mechanism designed to monitor and detect fire hazards. In some embodiments, the salt loop fire detection system identifies abnormal temperature rises that may indicate a fire.

Structurally, one example configuration of the salt loop fire detection system includes a continuous loop that features a tube (e.g., an Inconel tube or a stainless steel tube) filled with a thermally sensitive eutectic salt compound and a central wire electrode. When the ambient temperature rises above a predefined threshold, the salt mixture in the loop becomes conductive, completing an electrical circuit between the central wire and the outer sheath. This triggers an alarm signal, alerting the user to the presence of a fire or overheat condition. Once the temperature drops below the critical point, the salt re-solidifies, restoring the system to standby mode and ready to detect any subsequent anomalies.

In other implementations, the salt loop fire detection system features a continuous-loop design in which two electrical conductors (e.g., wires) are embedded within a tube (e.g., an Inconel tube or a stainless steel tube) filled with a thermistor-based core material. One conductor is grounded to the tube, while the other is connected to a fire detection control unit. As the temperature of the core material rises, its electrical resistance to ground decreases. The control unit continuously monitors this resistance. When the resistance drops to a predefined overheat threshold, an alarm signal is triggered. Once the overheat or fire condition subsides, the core material cools, and its resistance increases back to the reset point.

In some embodiments, the salt loop fire detection system advantageously detects an overheat or fire condition when any portion of the loop is exposed to the overheat or fire condition. The main advantage of this is that a localized “hot spots” will still trigger the alarm without having to have multiple loops in various areas. In some embodiments, one of the advantages of this configuration is that localized “hot spots” can still trigger the alarm without the need for multiple detection loops distributed throughout different areas of the vehicle 102.

In some examples, the salt loop fire detection system can be coupled to a portion of the vehicle 102 and can transmit a signal to the onboard computing device 136 to indicate a fire or overheat condition has been detected onboard the vehicle 102. In response, the onboard computing device 136 initiates the same actions as those triggered by the detector devices 104 described elsewhere herein. For example, the triggered actions can include extinguishing the fire in the refuse collection vehicle and/or alerting an operator of the vehicle 102 of the detected fire hazard.

In some embodiments, the salt loop fire detection system is designed to be highly resistant to environmental factors such as vibration, oil, water, and extreme temperatures, making it reliable in demanding environments. The salt loop fire detection system is configured in a loop circuit, allowing for continuous monitoring and rapid response without requiring manual reset. In some embodiments, the design of the salt loop fire detection system takes into account the unique properties of molten salt, such as its high operating temperature and chemical reactivity, ensuring reliable performance in extreme environments.

The salt loop fire detection system can be routed through areas where fire or overheat conditions are most likely to occur in the vehicle 102. In some implementations, the loop can be positioned along different areas of the storage body 114 to maximize fire detection coverage. For example, in some implementations, the loop can be routed throughout the storage body 114 of the vehicle 102. In some embodiments, the loop is positioned within the top portion or roof of the storage body 114. In some examples, the loop is mounted against the walls of the storage body 114. In some embodiments, the loop is placed on the floor of the storage body 114 and/or the hopper 108. In some implementations, the loop is installed on an ejector of the vehicle 102. In some embodiments, the loop can be routed along the upper sections of the inner walls of the hopper 108 to ensure optimal coverage of high-risk areas.

In some implementations, the loop can also be arranged in specific patterns such as, but not limited to, a zig-zag pattern, a U-shaped pattern, and continuous loop patterns, to enhance exposure and detection sensitivity. For example, the loop can be installed in three to four section loops to maximize exposure. Additionally, in some embodiments, the loop can be positioned to ensure maximum contact with the refuse materials within the storage body 114 and/or hopper 108. In some implementations, to tailor the system to specific refuse fire detection requirements, the different eutectic salt compounds for use with the salt loop fire detection system may be formulated, each with a distinct, targeted melting point. In some embodiments, the loop may be configured with a length suitable for the dimensions of the vehicle 102 (e.g., extending 100 feet or more) to ensure comprehensive coverage. In some implementations, the salt loop fire detection system is used in conjunction with any of the other sensors, other detector devices 104, and/or camera(s) 144 described herein to enhance fire detection reliability.

In addition, while the body sensor data 132, detector device data 134, and image data 146 have been described as being processed by the onboard computing device 136, in some implementations, the body sensor data 132, detector device data 134, and image data 146 are processed by a computing device that is remote from the vehicle 102.

Although the following detailed description contains many specific details for purposes of illustration, it is understood that one of ordinary skill in the art will appreciate that many examples, variations and alterations to the following details are within the scope and spirit of the disclosure. Accordingly, the exemplary implementations described in the present disclosure and provided in the appended figures are set forth without any loss of generality, and without imposing limitations on the claimed implementations.

Although the present implementations have been described in detail, it should be understood that various changes, substitutions, and alterations can be made hereupon without departing from the principle and scope of the disclosure. Accordingly, the scope of the present disclosure should be determined by the following claims and their appropriate legal equivalents.

The singular forms “a,” “an,” and “the” include plural referents, unless the context clearly dictates otherwise.

As used in the present disclosure and in the appended claims, the words “comprise,” “has,” and “include” and all grammatical variations thereof are each intended to have an open, non-limiting meaning that does not exclude additional elements or steps.

As used in the present disclosure, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is contemplated under the scope of the present disclosure.

Ranges may be expressed herein as from “about” one particular value and/or to “about” another particular value. When such a range is expressed, another embodiment includes from the one particular value and/or to the other particular value. The use of the term “about,” as used herein, refers to an amount that is near the stated amount by about 10% including increments therein. For example, “about” can mean a range including the particular value and ranging from 10% below that particular value and spanning to 10% above that particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

What is claimed is:

1. A system comprising:
a refuse collection vehicle, comprising:
a chassis;
a cab coupled to a front portion of the chassis;
a storage body coupled to the chassis rearward of the cab; and
at least one detector device coupled to a portion of the refuse collection vehicle, the at least one detector device configured to detect one or more phenomena resulting from a fire in the storage body of the refuse collection vehicle.

2. The system of claim 1, wherein the at least one detector device comprises one or more of a flame detector, a smoke detector, a heat detector, salt loop fire detection system, or a gas detector, and wherein the one or more phenomena comprises one or more of a flame, a spark, smoke, temperature, and gas.

3. The system of claim 2, wherein the gas detector is an oxygen detector configured to detect a decrease in oxygen resulting from the fire.

4. The system of claim 1, wherein the at least one detector device is coupled to a hopper, a hopper cover, or the storage body of the refuse collection vehicle.

5. The system of claim 4, wherein a field-of-view of the at least one detector device covers an interior space defined by the hopper or the storage body.

6. The system of claim 4, wherein the at least one detector device is coupled to a roof of the storage body.

7. The system of claim 1, wherein the refuse collection vehicle further comprises a camera configured to capture image data or video data of the one or more phenomena resulting from the fire in the refuse collection vehicle.

8. The system of claim 7, wherein the camera is an infrared (IR) camera.

9. The system of claim 1, wherein the refuse collection vehicle further comprises a fire suppression system comprising one or more of a clean agent-based fire suppression system, chemical clean agent-based fire suppression system, inert gas-based fire suppression system, and carbon dioxide-based fire suppression system.

10. The system of claim 1, further comprising a computing device, and the at least one detector device is configured to transmit, to the computing device, a signal indicating the one or more phenomena resulting from the fire has been detected in the refuse collection vehicle.

11. The system of claim 10, wherein the computing device is an onboard computing device of the refuse collection vehicle.

12. The system of claim 10, wherein the computing device is configured to trigger a fire suppression system of the refuse collection vehicle based on receiving the signal indicating the one or more phenomena resulting from the fire in the refuse collection vehicle has been detected, the fire suppression system configured to extinguish the fire in the refuse collection vehicle.

13. The system of claim 10, wherein the refuse collection vehicle comprises a display device within the cab, and the computing device is configured to display image data or video data of the one or more phenomena resulting from the fire in the refuse collection vehicle on the display device or to transmit the image data or the video data to one or more remote computing devices for display, based on receiving the signal indicating the one or more phenomena resulting from the fire in the refuse collection vehicle has been detected.

14. The system of claim 10, wherein, based on receiving the signal indicating the one or more phenomena resulting from the fire in the refuse collection vehicle has been detected, the computing device is configured to perform one or more of triggering an eject cycle, triggering a compaction cycle, triggering a packing cycle, triggering an activation of an ejector, or overriding a packing function of the refuse collection vehicle.

15. The system of claim 10, wherein the computing device is configured to generate a visual alert or an audible alert based on receiving the signal indicating the one or more the one or more phenomena resulting from the fire in the refuse collection vehicle has been detected.

16. A method of detecting one or more phenomena resulting from a fire in a refuse collection vehicle, the method comprising:
detecting, using at least one detector device coupled to the refuse collection vehicle, the one or more phenomena resulting from the fire;
transmitting, from the at least one detector device to a computing device, a signal indicating the one or more phenomena resulting from the fire has been detected by the at least one detector device; and
in response to receiving the signal, triggering, using the computing device, one or more actions comprising at least one of: i) extinguishing the fire in the refuse collection vehicle, or ii) alerting an operator of the refuse collection vehicle of the detected at one or more phenomena.

17. The method of claim 16, wherein the one or more phenomena comprises one or more of a flame, a spark, smoke, temperature, and gas.

18. The method of claim 16, wherein extinguishing the fire in the refuse collection vehicle comprises triggering a fire suppression system of the refuse collection vehicle, the fire suppression system configured to extinguish the fire in the refuse collection vehicle, wherein triggering the fire suppression system comprises triggering a release of one or more of a chemical agent, an inert gas, water, or carbon dioxide directed to a location of the one or more phenomena in the refuse collection vehicle.

19. The method of claim 16, wherein the refuse collection vehicle comprises a display device, and alerting an operator of the refuse collection vehicle of the one or more phenomena comprises displaying image data or video data of the one or more phenomena on the display device.

20. The method of claim 16, wherein triggering the one or more actions comprises one or more of overriding a packing function of the refuse collection vehicle, triggering a compacting cycle of the refuse collection vehicle, triggering an eject cycle of the refuse collection vehicle, triggering a packing cycle of the refuse collection vehicle, triggering an activation of an ejector of the refuse collection vehicle, or generating a visual alert or an audible alert indicating the one or more the one or more phenomena resulting from the fire in the refuse collection vehicle has been detected.
